(19) United States
(12) Patent Application Publication
(10) Pub. No.: US 2003/0024842 A1
(43) Pub. Date: Feb. 6, 2003

(54) Stick and dip condiment container

(76) Inventor: Barbara K. Blink, High Point, NC (US)

Correspondence Address: BARBARA K. BLINK, 5186 HIGH POINT ROAD, LOT 3, HIGH POINT, NC, 27265, US

(21) Appl. No.: 09/919,307

(22) Filed: Jul. 31, 2001

(51) Int. Cl. B65D 73/00; B65D 41/00; A45C 11/20; A21D 10/02

(52) U.S. Cl. 206/460; 220/359.1; 206/542; 426/110; 426/112

(57) ABSTRACT

A portable condiment container having a reservoir and a preferably having a removable and resealable lid or cover, and also having a covered adhesive attached to the exterior bottom portion of said reservoir such that the device can be resealably attached to a stable surface by first removing the liner from the adhesive attached to the bottom exterior of the container thus exposing the temporary adhesive, and then pressing the exposed adhesive onto a stable surface such as the dashboard of an automobile.

### FIELD OF THE INVENTION

The present invention relates generally to sealed condiment containers for food. More specifically the present invention relates to sealed condiment containers having adhesive means for removably securing the condiment container to a stable object while traveling, such as to the dashboard of an automobile, to prevent spillage.

### BACKGROUND OF THE INVENTION

Fast food has become a staple of millions of diets worldwide, and french fried potatoes, chicken nuggets, and fish sticks are among the most popular offerings of most fast food restaurants. Along with the high consumption of french fries, chicken nuggets, and other finger food, goes a high consumption of condiments, particularly ketchup and a variety of dipping sauces. One reason that fast food is so popular is that it can be eaten while on the go. Many people, driven by busy schedules, consume fast food while walking or riding in an automobile. This practice becomes difficult, however, when one desires to use ketchup or dipping sauce on one's food. One typically is forced to either pour the ketchup or sauce directly onto the food or find a convenient place to deposit it. Regardless, the user inevitably winds up spilling or dripping ketchup or sauce on their clothes or person, creating a mess and embarrassing stains. Accordingly, there is a need for a means by which one can dispense and use ketchup and other condiments while on the go, minimizing the resulting mess. The present invention fulfills this need.

### SUMMARY OF THE INVENTION

What is disclosed is a device for containing condiments for portable use, comprising a container having a bottom portion and vertical perimeter edges and an open top. A condiment may be injected into the container via the open top. The vertical perimeter edges turn outward at the top of said edges. In the preferred embodiment, after the insertion of a condiment, a cover is removably attached to the container covering the top opening. A securing means is attached to the external bottom of the container for removably securing said container to a surface such that, when said cover is peeled away, the condiment will be retained within said container and exposed for dipping a food item into the condiment.

It is an object of the present invention to provide a condiment container that stores ketchup, dressings, dipping sauces and the like, preventing them from spoiling or drying out.

It is another object of the present invention to provide a container having a dipping well that makes it easy to dip foods.

A further object of the present invention is to provide a condiment container having a means that secures the container to any stable surface such as a serving tray, table top, motor vehicle dashboard, etc., but is easily removed from the stable surface after use.

Another object of the present invention is to provide a self-adhesive condiment container that prevents messy spills, can be used with almost any condiment, eliminates the need to squeeze ketchup packages out onto food or wrappers and facilitates eating on-the-go.

### DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the Stick and Dip Condiment Container;

FIG. 2 is a side view of the Stick and Dip Condiment Container;

FIG. 3 is a side view of the Stick preferred embodiment, the temporary securing means is revealed;

FIG. 4 is a side view of the Stick and Dip Condiment Container illustrating how in the preferred embodiment, the cover is removed to reveal the corners of the container;

FIG. 5 is a perspective view of an alternative embodiment of an empty reservoir.

### DETAILED DESCRIPTION OF THE INVENTION

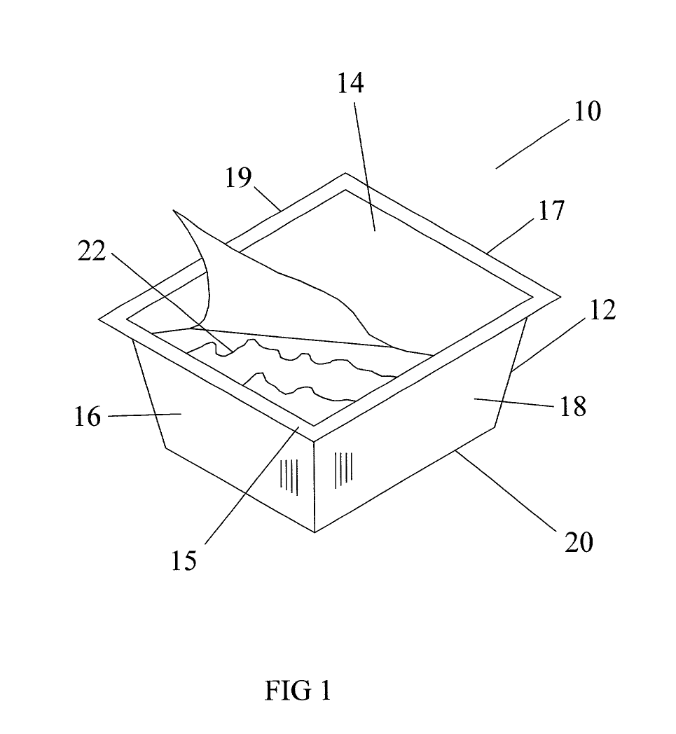

Referring first to FIG. 1, the Stick and Dip Condiment Container is generally designated as 10. In the preferred embodiment, the reservoir 12 is rectangular in shape and is comprised of side portions 16, 17 and front and back portions 18, 19, respectively, extending vertically upward and angled slightly outwardly from the bottom portion 20 to allow for a larger opening at the top for easier access to the material within the reservoir 12. One of ordinary skill in the art would recognize that the sides need not angle out from the bottom but can be straight up and down. In the preferred embodiment, the bottom portion 20 is a rectangular planar surface.

One of ordinary skill in the art would recognize, however that the reservoir 12 need not be rectangular in shape and can be round, square, oval, triangular, etc. See FIG. 5. The reservoir 12 is constructed of an impermeable material capable of containing a liquid condiment or other food. In the preferred embodiment the reservoir 12 is made out of plastic. It is further preferred that a cover 14 is attached about the peripheral flange 15 which projects outwardly from sides 16, 17 and front portion 18, 19 at the top. Cover 14 is partially peeled back in FIG. 1 to expose the contents of the Stick and Dip Condiment Container 10, comprised of an at least partially fluid condiment 22. It is preferred that the cover 14 is made out of foil. A number of other materials including plastic or wax paper can be used to make the cover 14 instead of foil. The cover 14 can also be removable and replaceable.

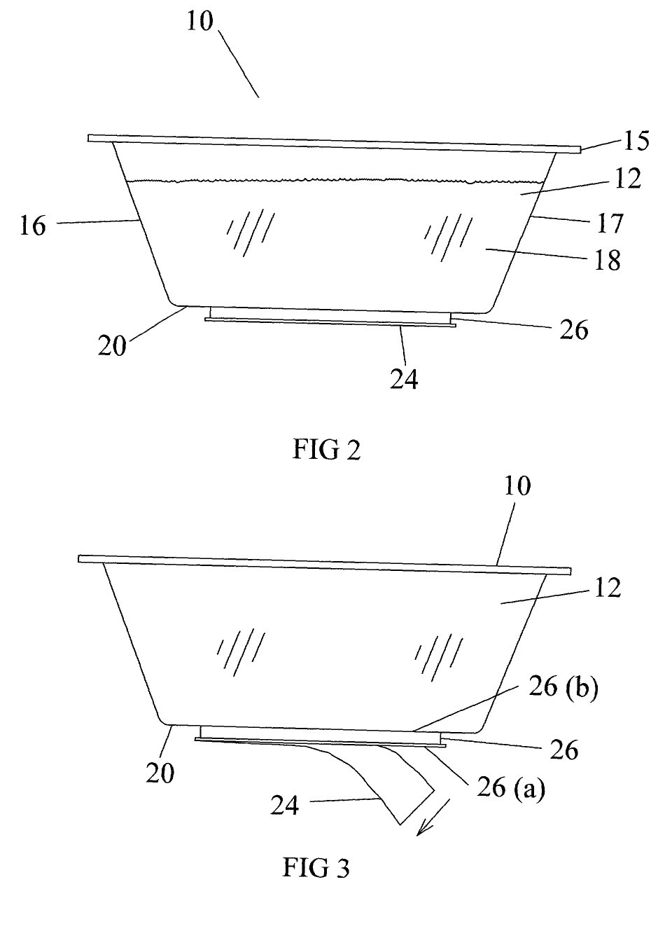

Referring next to FIG. 2, from the side view of the preferred embodiment, the bottom portion 20 is shown to have a foam adhesive strip 26 affixed thereto. Film strip 24 covers the downward side of the foam adhesive strip 26, to conceal a tacky adhesive, which is applied to the external side of the foam adhesive strip 26. One of ordinary skill in the art would readily recognize that a number of different methods could be used to attach a temporary adhesive to the external bottom of the reservoir 12, including but not limited to applying said adhesive directly to the reservoir 12 and covering it with a film strip 24. On the side adjacent to bottom portion 20, the foam adhesive strip 26 has an adhesive that is the same adhesive as applied to exterior side adjacent film 24, or alternatively, a more permanently bonding adhesive for permanently affixing the foam strip 26 to the external bottom 20 of the reservoir 12. One of ordinary skill in the art would recognize that a magnet or other adhesive means can be substituted for the foam adhesive strip 26 without altering the intent of the present invention. In FIG. 2, the contents of the Stick and Dip Condiment Container 10 can be seen through the preferably translucent plastic side 18. Side 16 is shown tapering outwardly from its bottom end adjacent the bottom 20 to the top end thereof which connects to flange 15 at the top opening.

Referring next to FIG. 3, the film strip 24 may be peeled away to expose surface 26a which has a tacky adhesive impregnated therein or applied thereto. The adhesive is capable of adhering to a stable surface 28 such as an automobile dashboard, a picnic table, a console of an automobile, or other area where movement may be involved and it is desirable to fix the position of the Stick and Dip Condiment Container 10 so that one may dip, for example, french fries, into the contents thereof. On the surface 26b of the foam strip 26, opposite of 26a, there is an adhesive that adheres the foam strip 26 to the exterior surface of the bottom 20. This adhesive as previously stated, may be a more permanent adhesive, as the foam strip desirably will remain in place. By contrast, surface 26a must be removable, and less adhesive in order to prevent damage to surfaces 28 where one is likely to stick the Stick and Dip Condiment Container 10.

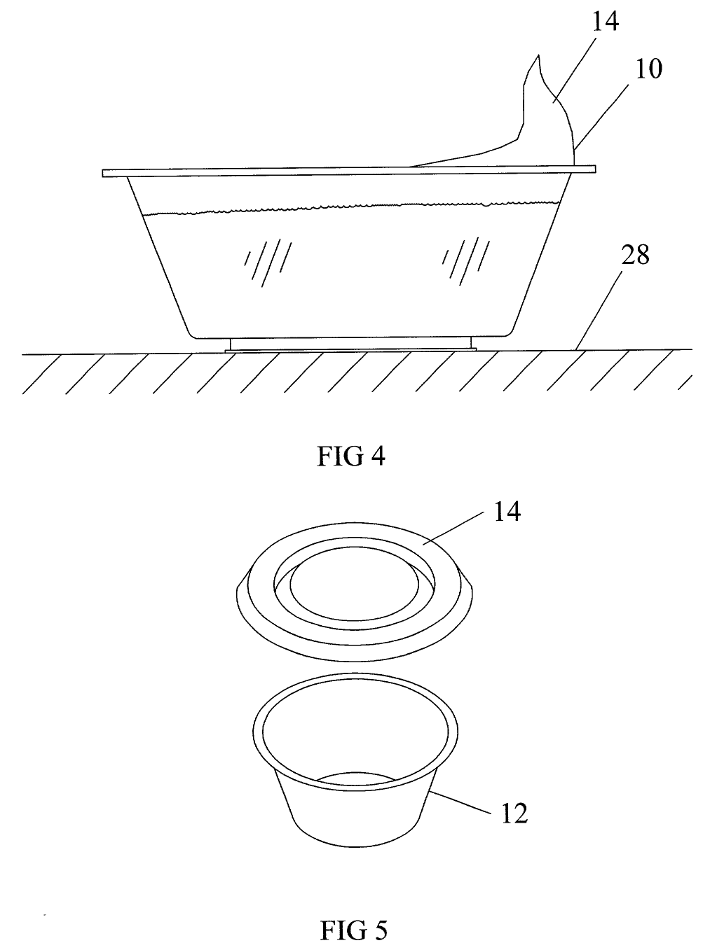

FIG. 4, illustrates how the Stick and Dip Condiment Container 10 is preferably attached to a stable surface 28. The stable surface 28 may be for example, the dashboard of an automobile, an automobile console, a park or picnic bench, or other surface where one may desire to consume food items, presumably while on the go. Cover 14 in this illustration is peeled backward to partially expose the contents of Stick and Dip Condiment Container 10.

As previously mentioned, FIG. 5, is a possible alternative embodiment of the reservoir 12 and the cover 14.

Although this invention has certain preferred embodiments, it will be obvious to those skilled in the art that various changes and modifications may be made therein without departing from the invention, and all such changes and modifications are intended to fall within the true spirit and scope of the invention.

I claim:

1. A portable condiment container comprising:
a reservoir having an open top portion, vertical sides and a bottom portion coupled to said vertical sides, said bottom portion having an interior and an exterior side; and,
a means coupled to the exterior side of the bottom portion of said reservoir, for removably fastening said reservoir to an object.

2. A portable condiment container comprising:
a reservoir having an open top portion, vertical sides and a bottom portion coupled to said vertical sides, said bottom portion having an interior and an exterior side;
a closed removable cover coupled to said reservoir such that it seals the open top portion of said reservoir for protecting and preserving the contents of said reservoir; and,
a means coupled to the exterior side of the bottom portion of said reservoir, for removably fastening said reservoir to an object.

3. The portable condiment container of claim 2 wherein said cover is resealable.
